(19) United States
(12) Patent Application Publication
(10) Pub. No.: US 2019/0220113 A1
(43) Pub. Date: Jul. 18, 2019

(54) TOUCH PANEL AND TOUCH DEVICE

(71) Applicant: BOE TECHNOLOGY GROUP CO., LTD., Beijing (CN)

(72) Inventors: Meizhu ZHENG, Beijing (CN); Yuanyuan LI, Beijing (CN); Lina LIU, Beijing (CN); Yanliu SUN, Beijing (CN)

(73) Assignee: BOE TECHNOLOGY GROUP CO., LTD., Beijing (CN)

(21) Appl. No.: 16/174,664

(22) Filed: Oct. 30, 2018

(30) Foreign Application Priority Data
Jan. 12, 2018 (CN) 201810031373.3

(51) Int. Cl. G06F 3/044; G06K 9/00

(52) U.S. Cl. CPC G06F 3/044; G06K 9/0004

(57) ABSTRACT

A touch panel and a touch device are disclosed. The touch panel includes a base substrate and at least one touch electrode. The at least one touch electrode is on the base substrate, each of the at least one touch electrode is formed by a continuous conductive layer, and the at least one touch electrode has at least one via hole penetrating the conductive layer.

The present application claims priority of a Chinese Patent application No. 201810031373.3 filed on Jan. 12, 2018, the content of which is incorporated in its entirety as portion of the present application by reference herein.

### TECHNICAL FIELD

At least one embodiment of the present disclosure relates to a touch panel and a touch device.

### BACKGROUND

With the development of technology, touch panels have become more and more widely used. The touch panels replace the mechanical button panels by utilizing a tactile feedback system, so as to provide a simple and convenient way of human-computer interaction. According to different working principles, the touch panels include capacitive, resistive, infrared, and surface acoustic wave types. Capacitive touch panel works by utilizing the current sensing phenomenon of human body, can support multi-touch, and has the advantages of wear resistance, long life, low power consumption, etc., and thus has been rapidly developed.

In recent years, fingerprint recognition technologies have been widely used in various electronic devices, and combined with touch technology, display technology and the like. The fingerprint recognition technologies include a capacitive fingerprint recognition technology and an optical fingerprint recognition technology. The optical fingerprint recognition technology utilizes the principle of optical imaging to achieve fingerprint recognition, and has the advantages of high resolution, simple structure, low cost, and being hard to be damaged. Thus, it has become one of the most widely used fingerprint recognition technologies.

### SUMMARY

At least one embodiment of the present disclosure provides a touch panel, including: a base substrate; and at least one touch electrode on the base substrate, each of the at least one touch electrode is formed by a continuous conductive layer, and one or more of the at least one touch electrode has at least one via hole penetrating the conductive layer.

In some examples, the touch panel further includes: a fingerprint recognition component on a side opposite to an operation surface of the touch panel.

In some examples, the fingerprint recognition component includes a light source, the light source being configured such that light emitted from the light source passes through the touch electrode at least through the via hole.

In some examples, the fingerprint recognition component includes a light sensor, the light sensor is configured to sense light reflected at the operation surface of the touch panel and passing through the at least one via hole in the touch electrode.

In some examples, a material of the at least one touch electrode is a transparent conductive material.

In some examples, the at least one touch electrode is configured to perform a touch detection operation through a self-capacitance manner or a mutual capacitance manner.

In some examples, the at least one touch electrode includes a plurality of via holes which are uniformly distributed.

In some examples, the via hole is filled with a transparent material, and an absolute value of a difference between a refractive index of the transparent material and a refractive index of the base substrate is smaller than an absolute value of a difference between a refractive index of the at least one touch electrode and the refractive index of the base substrate.

In some examples, the touch panel further includes: a protective layer on the at least one touch electrode, a portion of the protective layer is filled in the at least one via hole to serve as the transparent material filled in the at least one via hole.

In some examples, a section of the via hole parallel to the base substrate has a shape of at least one selected from the group consisting of a circle, a rectangle, and a hexagon.

In some examples, the via hole has a hole diameter of 0.3 to 0.6 mm

In some examples, the at least one touch electrode includes a plurality of touch electrodes, the plurality of touch electrodes are arranged in a two-dimensional array, and the touch electrodes arranged in a row direction or in a column direction among the plurality of touch electrodes are connected in series by a plurality of bridge portions, and the via hole is outside the plurality of bridge portions.

In some examples, the touch panel includes a fingerprint detection area, and the at least one via hole is in the touch electrode located in the fingerprint detection area.

In some examples, the touch panel further includes a polarizer on a side of the touch electrode away from the base substrate.

At least one embodiment of the present disclosure provides a touch device, including any one of the abovementioned touch panels.

In some examples, the touch device further includes a display structure configured to display according to display data.

In some examples, the display structure includes a display light source configured to also serve as a light source for fingerprint recognition, and light emitted by the display light source passes through the touch electrode at least through the via hole.

In some examples, the display structure includes at least one selected from the group consisting of an organic light emitting diode display array, a quantum dot light emitting diode display array, and a liquid crystal display module.

### BRIEF DESCRIPTION OF THE DRAWINGS

In order to clearly illustrate the technical solution of embodiments of the present disclosure, the drawings of the embodiments will be briefly described in the following, it is obvious that the drawings in the description are only related to some embodiments of the present disclosure and not limited to the present disclosure.

FIG. 1 is a plan view of a touch electrode structure of a touch panel;

FIG. 2 is a schematic sectional diagram of a touch panel;

FIG. 3 is a plan view of a touch electrode structure of a touch panel provided by an embodiment of the present disclosure;

FIG. 4 is a schematic sectional diagram of a touch panel provided by an embodiment of the present disclosure;

FIG. 5 is a schematic sectional diagram of another touch panel provided by an embodiment of the present disclosure;

FIG. 6 is a plan view of a touch electrode structure of another touch panel provided by an embodiment of the present disclosure;

FIG. 7 is a plan view of a touch electrode structure of another touch panel provided by an embodiment of the present disclosure;

FIG. 8 is a schematic sectional diagram of a touch device provided by an embodiment of the present disclosure;

FIG. 9 is a schematic sectional diagram of another touch device provided by an embodiment of the present disclosure; and

FIG. 10 is a schematic appearance diagram of another touch device provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. Also, the terms “a,” “an,” or “the,” etc., are not intended to indicate any amount, but indicates that at least one exists. The terms “include,” “including,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

In electronic devices, optical fingerprinting technology can be applied in combination with touch technology. For example, a component having an optical fingerprint recognition function can be integrated in the touch panel, so that the touch panel has both a touch function and an optical fingerprint recognition function. For example, the touch panel may include a base substrate and a touch electrode. Upon light used for fingerprint recognition is incident on the touch electrode from the base substrate or from the touch electrode to the base substrate, because there is a large difference in refractive indexes between the base substrate and the touch electrode, an interface of the touch electrode and the base substrate reflects more light, so as to causes large light loss, thereby making the imaging of optical fingerprint recognition unclear and affecting the recognition effect.

At least one embodiment of the present disclosure provides a touch panel and a touch device. By providing a hole structure in the touch electrode to lower the reflectance of light at an interface of the hole structure, light loss is reduced, imaging clarity is improved, which facilitates partial or full-screen application of optical fingerprint recognition.

Hereinafter, embodiments of the present disclosure will be described in detail with reference to the accompanying drawings. It should be noted that the same reference numerals will be used in the different drawings to refer to the same elements that have been described.

At least one embodiment of the present disclosure provides a touch panel. The touch panel includes a base substrate and at least one touch electrode. The at least one touch electrode is on the base substrate, each of the at least one touch electrodes is formed by a continuous conductive layer, and at least a part (for example, one or more) of the at least one touch electrode has at least one hole structure penetrating the conductive layer. In other words, in a case where the at least one touch electrode includes only one touch electrode, the touch electrode is provided with a hole structure; in a case where the at least one touch electrode includes a plurality of touch electrodes, a part or all of the plurality of touch electrodes are provided with the hole structure.

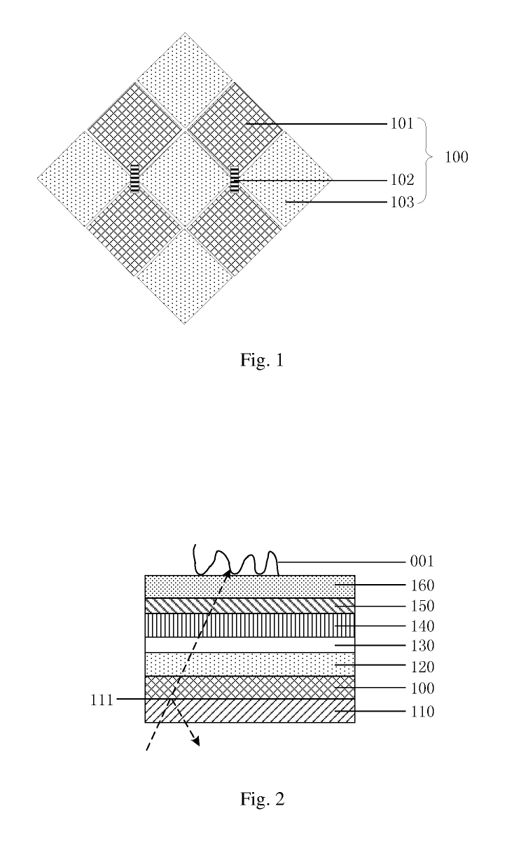

FIG. 1 is a schematic plan view showing a touch electrode structure of a touch panel. Referring to FIG. 1, the touch electrode structure 100 includes a touch sensing electrode 101, a bridge portion 102, and a touch scanning electrode 103. The touch sensing electrode 101 and the touch scanning electrode 103 may be collectively referred to as touch electrodes. The touch sensing electrode 101 and the touch scanning electrode 103 are disposed across each other and insulated from each other. The touch sensing electrode 101 and the touch scanning electrode 103 are located in the same layer and have a diamond-shaped block structure. The adjacent touch scanning electrodes 103 are connected by a connection portion integral with the touch scanning electrodes 103. The adjacent touch sensing electrodes 101 are connected by a bridge portion 102 that crosses with the abovementioned connecting portion. For example, the touch sensing electrode 101 and the touch scanning electrode 103 are made of a transparent conductive material. Upon light used for fingerprint recognition passing through the touch electrode, the light will be refracted and reflected at the same time on a lower surface and an upper surface of the touch electrode, and the reflection will cause light loss, which affects the effect of optical fingerprint recognition.

FIG. 2 is a schematic cross-sectional view of a touch panel. Referring to FIG. 2, the touch panel includes a base substrate 110, a touch electrode structure 100, a protective layer 120, a pressure sensitive adhesive 130, a polarizer 140, an optical adhesive 150, and a cover plate 160. The above structures are stacked in an order. The touch electrode structure 100 includes at least one touch electrode.

Upon light used for fingerprint recognition (dashed line shown in the figure) being incident on the touch electrode structure 100 from the base substrate 110, the light is refracted and reflected at the interface 111. The refracted light continues to propagate through the touch panel to be used for detection of a fingerprint 001 located on the cover plate 160. A direction of propagation of the reflected light is deflected, and the reflected light cannot reach the fingerprint 001, thereby causing light loss.

For example, the reflectance of the light at the interface 111 can be expressed as: n=[(n1−n2)/(n1+n2)]², wherein n represents the reflectance of the light at the interface 111, n1 represents a refractive index of the base substrate 110, and n2 represents a refractive index of the touch electrode. As seen, the reflectance of the light at the interface 111 is related to the refractive index of the base substrate 110 and the refractive index of the touch electrode; the difference between the refractive index of the base substrate 110 and the refractive index of the touch electrode is smaller, the reflectance of light at the interface 111 is smaller, and the light loss is smaller.

For example, a material of the touch electrode is a transparent conductive material, such as Indium Tin Oxide (ITO), having a refractive index greater than 2. A material of the base substrate 110 is a cycloolefin polymer, having a refractive index of 1.63. Refractive indexes of the protective layer 120, the pressure sensitive adhesive 130, the polarizer 140, the optical adhesive 150, and the cover plate 160 are all less than 1.5. Therefore, the difference between the refractive indexes of the touch electrode and the substrate 110 is large, and the reflectance of the light at the interface 111 is large, resulting in large light loss. For example, after light emitted from the base substrate 110 is incident on the fingerprint 001 and returned to the base substrate 110, the return light is approximately 2% of the emitted light. As seen, in the touch panel, the light loss is large, and the requirements for optical fingerprint recognition cannot be satisfied.

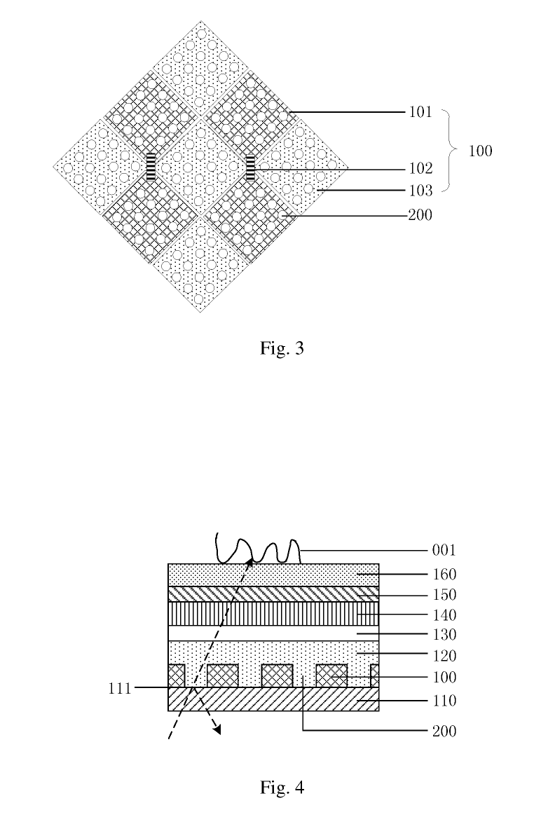

FIG. 3 is a schematic plan view of a touch electrode structure of a touch panel provided by an embodiment of the present disclosure. Referring to FIG. 3, the touch electrode structure 100 includes a touch sensing electrode 101, a bridge portion 102, and a touch scanning electrode 103. The touch sensing electrode 101 and the touch scanning electrode 103 have a hole structure 200. Both the touch sensing electrode 101 and the touch scanning electrode 103 are exemplary structures of the touch electrodes. For example, the hole structure 200 may be in the touch sensing electrode 101, or the hole structure 200 may be in the touch scanning electrode 103, or the hole structure 200 may be in both the touch sensing electrode 101 and the touch scanning electrode 103. For example, the touch electrodes according to the embodiment of the present disclosure are configured to perform a touch detection operation through a self-capacitance manner or a mutual capacitance manner. The hole structure 200 penetrates the touch electrode in a thickness direction, in other words, the hole structure 200 is a via hole penetrating the touch electrode.

The touch sensing electrodes 101 and the touch scanning electrodes 103 are respectively formed by a continuous conductive layer, insulated from each other, and arranged in a two-dimensional array. The touch scanning electrodes 103 are disposed along a first direction (a horizontal or row direction in the figure), and the touch sensing electrodes 101 are disposed in a second direction (a longitudinal or column direction in the figure) crossing the first direction. For example, the first direction and the second direction are perpendicular to each other, in other words, an angle between the first direction and the second direction is 90 degrees. Of course, the embodiments of the present disclosure are not limited thereto, and the first direction and the second direction may be any direction, and the angle between the first direction and the second direction is not limited to 90 degrees.

For example, the adjacent touch scanning electrodes 103 are connected by a connection portion integral with the touch scanning electrodes 103, and the adjacent touch sensing electrodes 101 are connected by a bridge portion 102 crossing the connection portion. The touch sensing electrodes 101 and the touch scanning electrodes 103 are located in the same layer. The bridge portion 102 is located at a different layer from the touch sensing electrode 101, and is connected to the adjacent touch sensing electrodes 101 such that the touch sensing electrodes 101 are connected in series with each other. It should be noted that, in the embodiments of the present disclosure, the shapes of the touch sensing electrode 101 and the touch scanning electrode 103 are not limited to the diamond shape in the figure, and may be any other shape, such as a rectangle, a triangle, a circle, or the like.

The hole structure 200 is disposed to penetrate through the touch sensing electrode 101 and the touch scanning electrode 103. Because the hole structure is provided, more reflection due to a large difference between the refractive indexes at the interface can be prevented at the hole structure. Therefore, the light transmittance of the touch panel can be improved. For example, in order to increase the light transmittance of the entire touch panel, via holes may be in all of the touch electrodes on the entire touch panel, but embodiments of the present disclosure are not limited thereto.

For example, light used for fingerprint recognition may pass through the touch electrode structure 100 through the hole structure 200. The number of the hole structures 200 is not limited and may be one or more. For example, a plurality of hole structures 200 are separated from each other and uniformly distributed. For example, each of the touch electrodes includes a plurality of hole structures, and the plurality of hole structures are uniformly distributed in each of the touch electrodes. The uniform distribution of the hole structures 200 can make the light more uniform and make the electrical performance of the touch electrode structure 100 more uniform. For example, the hole structure 200 is outside the bridge portion 102 (i.e., avoiding the bridge portion 102) to reduce the impact on the electrical performance of the touch electrode structure 100. For example, in a case where fingerprint recognition is performed, the hole structure may be provided only in the touch electrode in a fingerprint detection area of the touch panel to improve the transmittance of the light used for fingerprint recognition.

A sectional shape of the hole structure 200 parallel to the base substrate (not shown in FIG. 3) may be a circular shape, or any shape such as a rectangle, a hexagon, or the like, so as to comply with various production processes. The hole structure 200 may be filled with a transparent material such as a transparent organic material or a transparent inorganic material to increase the light transmittance and reduce the reflectance at the interface of the hole structure 200. For example, an absolute value of a difference between a refractive index of the transparent material and a refractive index of the base substrate is smaller than an absolute value of a difference between a refractive index of the touch electrode and the refractive index of the base substrate. The hole structure 200 can be in all of the touch sensing electrodes 101 and/or the touch scanning electrodes 103, or can be only in a part of the touch sensing electrodes 101 and/or the touch scanning electrodes 103, which can be determined by the requirements of optical fingerprint recognition. The hole structure 200 may be uniformly distributed or unevenly distributed, and the embodiments of the present disclosure are not limited thereto.

It should be noted that, in the embodiments of the present disclosure, the touch electrode structure 100 may include a self-capacitive touch electrode structure or a mutual capacitive touch electrode structure. The touch electrode structure 100 may be a single layer or multiple layers. A material of the touch electrode structure 100 may be a transparent conductive material, such as Indium Tin Oxide (ITO) or Indium Zinc Oxide (IZO), or other suitable materials, so as to ensure optical visibility. The bridge portion 102 can be disposed or omitted according to the specific structural form of the touch electrode structure 100. For example, in an example, the touch sensing electrode 101 and the touch scanning electrode 103 are located at different layers, so that the rows (columns) formed by the touch sensing electrodes and the columns (rows) formed by the touch scanning electrodes are crossing with each other and insulated from each other. Thus, the bridge portion 102 can be omitted. The manufacturing process of this configuration is simple, and is easy to implement. For example, in another example, the adjacent touch sensing electrodes 101 are connected by a connecting portion integral with the touch sensing electrodes 101, and the touch scanning electrodes 103 are connected with each other through the bridge portions 102.

FIG. 4 is a sectional view of a touch panel according to an embodiment of the present disclosure. Referring to FIG. 4, the touch panel includes a base substrate 110, a touch electrode structure 100, a protective layer 120, a pressure sensitive adhesive 130, a polarizer 140, an optical adhesive 150, and a cover plate 160.

The base substrate 110 serves as a carrier for supporting, protecting, and the like, may be a glass substrate, a plastic substrate, or the like, and may adopt a cycloolefin polymer or other suitable material. The touch electrode structure 100 is on the base substrate 110 and includes at least one touch electrode, and the touch electrode has a plurality of hole structures 200. The protective layer 120 is on the touch electrode structure 100, and has main functions including protection and insulation. A material of the protective layer 120 is not limited and may be an inorganic insulating material such as silicon oxide, silicon nitride, or an organic insulating material such as a resin, or other suitable materials. As illustrated by FIG. 4, a portion of the protective layer 120 on the touch electrode structure 100 is filled in the hole structure 200, and the portion of the protective layer filled in the hole structure 200 serve as the transparent material filled in the hole structure 200.

The polarizer 140 is on the protective layer 120 and bonded to the protective layer 120 through the pressure sensitive adhesive 130. The polarizer 140 can filter stray light, avoid unnecessary optical path interference, and improve detection accuracy. The polarizer 140 may be, for example, a polyvinyl alcohol (PVA) film prepared by a stretching process or a wire grid obtained by a patterning process. The cover plate 160 is on the polarizer 140 and is integrally bonded to the polarizer 140 by the optical adhesive 150. The main function of the cover plate 160 includes protection, insulation and support. A material of the cover plate 160 can be glass, plastic, ceramic material or other suitable materials.

In the present embodiment, the hole structure 200 may be filled with a transparent material, and the transparent material may be an organic material or an inorganic material, and the embodiments of the present disclosure are not limited thereto. For example, an absolute value of the difference between the refractive index of the transparent material and the refractive index of the base substrate 110 is smaller than an absolute value of the difference between the refractive index of the touch electrode and the refractive index of the base substrate 110. Upon light (the dash line shown in the figure) passing through the hole structure 200, the reflectance at the interface 111 is smaller than the reflectance upon the light directly passing through the touch electrode, thereby reducing the light loss and making more light be reflected back from the fingerprint 001, which is facilitate to the realization of optical fingerprint recognition. On the other hand, for the same reason, the light reflected back from the fingerprint 001 has a low reflectance at the interface 111, which is also facilitate to reducing the loss of fingerprint recognition light, thereby improving the definition of optical fingerprint recognition. For example, in an example, the material filled in the hole structure 200 is the same as the material of the protective layer 120, so that the filling operation can be completed in the process of manufacturing the protective layer 120, thereby simplifying the processes, reducing the production cost, and improving the production efficiency.

The manner of filling the transparent structure in the hole structure 200 is not limited herein. For example, in an example, the transparent material is only filled in the hole structures 200, and thus the transparent materials in the hole structures 200 are separated from each other, which can save material without affecting the thickness of the touch panel. For example, in another example, the transparent material is not only filled in the hole structures 200, but also forms a continuous cover layer on the hole structures 200, which simplifies the filling process and facilitates manufacturing.

The abovementioned embodiment is described by taking a case where light passes through the hole structure 200 as an example. However, the light may also pass through other portions of the touch electrode than the hole structure 200 of the touch electrode.

A size of the hole structure 200 is not limited and may depend on the specific requirements of the optical fingerprint recognition. For example, in a direction parallel to the plate surface of the base substrate 110, a maximum dimension of a section of the hole structure 200 is 0.3-0.6 mm, so that a relatively good imaging definition can be guaranteed, and the electrical performance of the touch electrode structure 100 is not affected. For example, the hole structure 200 has a hole diameter of 0.3 to 0.6 mm For example, in a case where the section of the hole structure 200 in a direction parallel to the base substrate 110 has a circular shape, the hole diameter is the diameter of the circular shape; in a case where the section has a rectangular shape, the hole diameter is a length of a diagonal of the rectangle shape. Or, in a case where the section has a hexagon shape, the hole diameter is a length of the longest diagonal of the hexagon. The density of the hole structure 200 can also be arbitrarily adjusted according to the requirements on the transmittance without affecting the electrical performance of the touch electrode.

It should be noted that, in the embodiments of the present disclosure, the touch panel is not limited to the abovementioned structural form, and may be any structural form, and may also include more or fewer components. The relative positional relationship of the components may be determined according to actual requirements. However, embodiments of the present disclosure are not limited thereto.

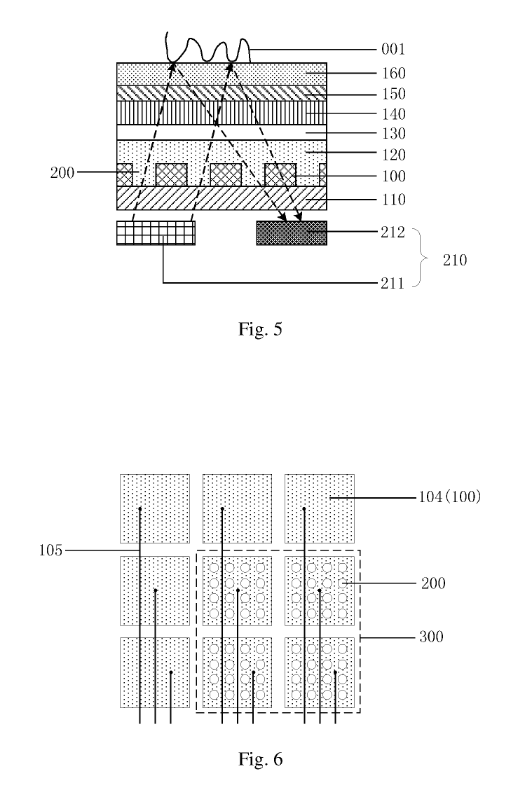

FIG. 5 is a sectional view of another touch panel provided by an embodiment of the present disclosure. Referring to FIG. 5, on the basis of the touch panel described with reference to FIG. 4, the touch panel of the present embodiment further includes a fingerprint recognition component 210. In the present embodiment, the fingerprint recognition part 210 is on a side of the touch panel opposite to the operation surface side. The operation surface side refers to a side where a finger contacts the touch panel (for example, a side where the fingerprint 001 contacts the touch panel). The fingerprint recognition component 210 includes a light source 211 and a light sensor 212.

The light source 211 is used as a light source for fingerprint recognition, and light emitted by the light source (dashed line shown in the figure) passes through the touch electrode structure 100 through the hole structure 200 and is directed to the fingerprint 001. The light source 211 can be a surface light source, a line light source, a point light source or other suitable light source, and the aforementioned surface light source can also be obtained by combining a line light source or a point light source. The light source 211 can be a uniform light source or a non-uniform light source. The light source 211 can be an ordinary light source or a polarized light source, and the embodiments of the present disclosure are not limited thereto. For example, upon the light source 211 being a polarized light source, its polarization direction coincides with a polarizing direction of the polarizer 140.

The light sensor 212 is configured to sense light emitted by the light source 211 and reflected at the operation surface of the touch panel (i.e., light reflected by the fingerprint 001). The reflected light may pass through the hole structure 200 to reach the light sensor 212, or may pass through the touch electrode to reach the light sensor 212. The light sensor 212 may be a CMOS image sensor, a CCD image sensor or other suitable image sensor, or may be a photodiode array or a photomultiplier tube array or the like.

The relative positional relationship between the light source 211 and the hole structure 200 is not limited herein, and the light sources 211 and the hole structure 200 may be overlapped in a direction perpendicular to the plate surface of the base substrate 110, or may be stagger with each other. For example, in an example, the light emitted by the light source 211 propagates in a direction perpendicular to the plate surface of the base substrate 110; thus, the light source 211 is disposed to be overlapped with the hole structure 200, so that the light can pass through the hole structure 200. For example, in another example, the light emitted by the light source 211 propagates in a direction at a certain angle (for example, the angle is less than 90 degrees) with the plate surface of the base substrate 110; thus, the light source 211 can be disposed to be stagger with the hole structure 200, as long as the light can pass through the hole structure 200. Similarly, the relative positional relationship between the light sensor 212 and the hole structure 200 is not limited herein, and the light sensor 212 and the hole structure 200 may be overlapped in a direction perpendicular to the plate surface of the base substrate 110, or may be stagger with each other, as long as the reflected light can be incident on the light sensor 212.

It should be noted that, in the embodiments of the present disclosure, the fingerprint recognition component 210 may not only include the light source 211 and the light sensor 212, but also include more components, such as an image processing chip, an optical prism, etc., or may also include fewer components, the embodiments of the present disclosure are not limited thereto. The fingerprint recognition component 210 may be integrally bonded to the base substrate 110, or may be provided in a separate manner. The light source 211 and the light sensor 212 may be two separate devices from each other, or may be an integrated device.

FIG. 6 is a schematic plan view of a touch electrode structure of another touch panel provided by an embodiment of the present disclosure. Referring to FIG. 6, the touch electrode structure 100 includes a plurality of touch electrodes 104 distributed in a two-dimensional array. The fingerprint detection area 300 includes a part of the touch electrodes 104. Each of the touch electrodes 104 located in the fingerprint detection area 300 has a hole structure 200. The hole structure 200 is only on the touch electrode 104 in the fingerprint detection area 300, which can simplify the manufacturing process and reduce the production cost while ensuring the fingerprint recognition function. The fingerprint detection area 300 may be any regular shape such as a rectangle or a circle or irregular shape. The fingerprint detection area 300 can include any number of touch electrodes 104. The features such as the shape, distribution, size, filling material and the like of the hole structure 200 are similar to those described in the abovementioned embodiments, and will be omitted herein.

In FIG. 6, the plurality of touch electrodes 104 are insulated from each other and arranged in a matrix. The touch electrodes 104 may have a square shape, or may have other shapes such as a rectangle shape, a circle shape, a hexagon shape, a triangle shape, and the like. The arrangement of the plurality of touch electrodes 104 is not limited and can be determined according to actual requirements. The size of the touch electrode 104 is not limited. For example, in an example, the size of the touch electrode 104 is 5 mm*5 mm, so as to meet the requirements on detection accuracy of finger touch, while reducing the number of the touch electrodes 104 as much as possible.

Each touch electrode 104 is electrically connected to a corresponding signal line 105 to transmit a touch signal. The touch electrode 104 and the signal line 105 may be in the same layer or in different layers. For example, in one example, the touch electrodes 104 and the signal lines 105 are in different layers, and the touch electrodes 104 cover the signal lines 105 and are electrically connected through the via holes, thereby reducing the distance between the adjacent touch electrodes 104 and avoiding touch dead zones. For example, in another example, the touch electrodes 104 and the signal lines 105 are in the same layer, and the signal lines 105 are located between the adjacent touch electrodes 104, thereby simplifying the manufacturing process and reducing the production costs.

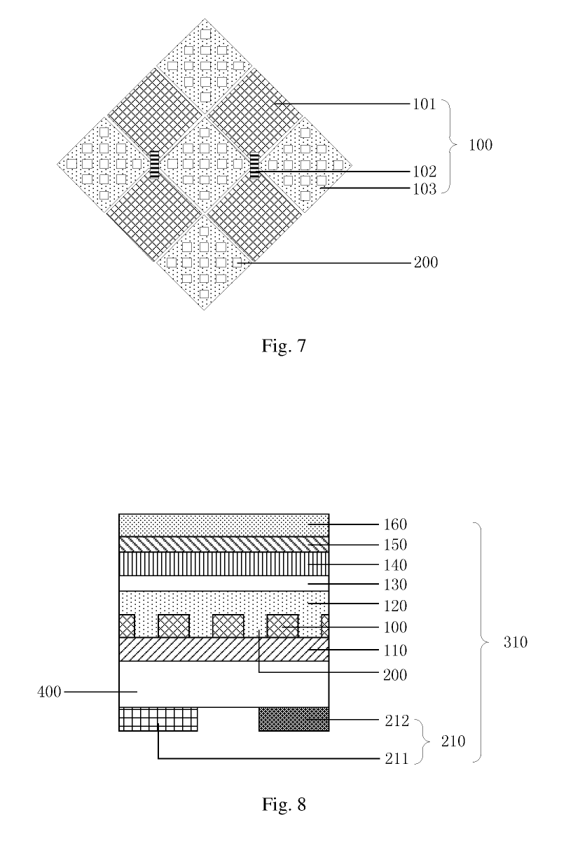

FIG. 7 is a schematic plan view of a touch electrode structure of another touch panel provided by an embodiment of the present disclosure. Referring to FIG. 7, the touch electrode structure of the present embodiment is substantially the same as the touch electrode structure described in FIG. 3 except for the shape and distribution of the hole structure 200. In the present embodiment, the shape of the section of the hole structure 200 parallel to the base substrate (not shown in FIG. 7) is a square shape. Of course, embodiments of the present disclosure are not limited thereto, and the hole structure 200 may be any shape such as a circle shape, a rectangle shape, a hexagon shape, or the like, so as to accommodate various production processes.

The hole structure 200 is disposed to penetrate the touch scanning electrode 103, and is not in the touch sensing electrode 101. The hole structure 200 is only on a part of the touch electrodes, which can simplify the manufacturing process and reduce the production costs while ensuring the fingerprint recognition function. Of course, the embodiments of the present disclosure are not limited thereto. The hole structure 200 may also be only in the touch sensing electrode 101, and may also be in a part of the touch scanning electrodes 103 and/or a part of the touch sensing electrodes 101.

At least one embodiment of the present disclosure further provides a touch device including the touch panel according to any one of the embodiments of the present disclosure. In the touch device, a reflectance of light at the interface of the hole structure is relatively low, thereby reducing light loss, improving image clarity, and facilitating partial or full-screen application of optical fingerprint recognition.

FIG. 8 is a sectional view of a touch device provided by an embodiment of the present disclosure. Referring to FIG. 8, the touch device includes a touch panel 310 and a display structure 400. The touch panel 310 is the touch panel according to any embodiment of the present disclosure. For example, the display structure 400 is on an opposite side of a side of the operation surface of the touch panel. For example, the display structure 400 is between the base substrate 110 and the fingerprint recognition component 210. Of course, the embodiments of the present disclosure are not limited thereto, and the specific position and specific structural form of the display structure 400 are not limited herein, and may be determined according to actual requirements. For example, in an embodiment, the fingerprint recognition component 210 is between the display structure 400 and the base substrate 110, and the touch panel is on a side of the display surface of the display structure. For example, in an example, the touch panel 310 and the display structure 400 have an in-cell structure, so that the touch panel 310 and the display structure 400 are integrated, and the touch electrode structure 100 in the touch panel 310 may be directly on an array substrate or an opposite substrate in the display structure 400. For example, the fingerprint recognition component may also be between the array substrate and the opposite substrate. The display structure 400 is configured to display according to the display data, and may include any one selected from the group consisting of an organic light emitting diode display array, a quantum dot light emitting diode display array, a liquid crystal display module, an electronic paper display module, and the like, the embodiments of the present disclosure are not limited thereto.

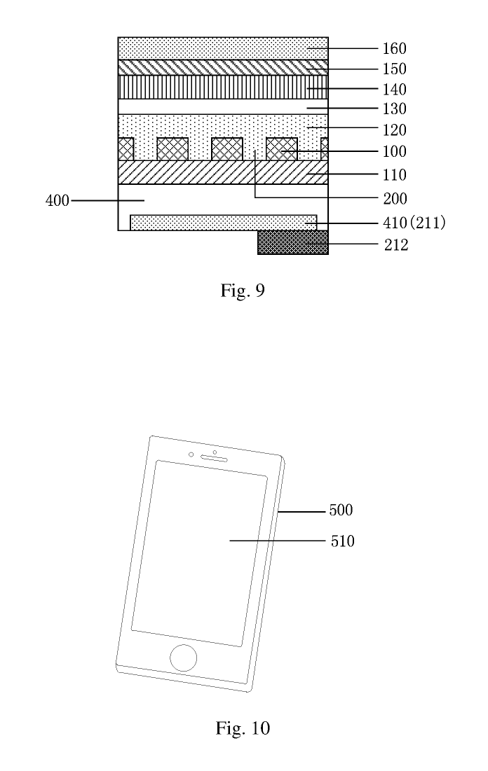

FIG. 9 is a sectional view of another touch device provided by an embodiment of the present disclosure. Referring to FIG. 9, the touch device of the present embodiment is substantially the same as the touch device described in FIG. 8 except for the manner in which the light source 211 is disposed. In the present embodiment, the display structure 400 includes a display light source 410. The display light source 410 functions both as a light source for the display structure 400 and as a light source 211 for fingerprint recognition. In this way, the quantity of the components can be reduced, and the integration and reliability can be increased.

For example, a side of the display structure 400 adjacent to the light sensor 212 is provided with a light transmission hole, and light emitted by the display light source 410 and reflected at the operation surface of the touch panel can be irradiated onto the light sensor 212 through the light transmission hole. The display light source 410 can be a surface light source, a line light source, a point light source or other suitable light source, and the aforementioned surface light source can also be obtained by combining a line light source or a point light source. Display source 410 can be a uniform source or a non-uniform source. Display source 410 can be a normal source or a polarized source. The specific position of the display light source 410 may be determined according to actual requirements, and the embodiments of the present disclosure are not limited thereto.

FIG. 10 is a schematic appearance diagram of another touch device provided by an embodiment of the present disclosure. Referring to FIG. 10, the touch device is a mobile phone 500 including a touch panel 510. The touch panel 510 is a touch panel according to any of the embodiments of the present disclosure. Certainly, the embodiments of the present disclosure include but are not limited thereto. The touch device may also be an electronic device having a display function, such as an electronic book, a tablet computer, a notebook computer, a game machine, a display, a digital photo frame, a navigator, etc., or may be electronic devices that do not have a display function, such as a solar touch panel, an infrared detection panel, and the like.

The following points should to be explained:

(1) The accompanying drawings involve only the structure(s) in connection with the embodiment(s) of the present disclosure, and other structure(s) can be referred to common design(s).

(2) In the case of no conflict, the features of the embodiments and the embodiments of the present disclosure may be combined with each other to obtain a new embodiment.

The above is only a specific embodiment of the present disclosure, but the scope of protection of the present disclosure is not limited thereto, and the scope of protection of the present disclosure is subject to the scope of protection of the claims.

What is claimed is:

1. A touch panel comprising:
a base substrate; and
at least one touch electrode on the base substrate,
wherein each of the at least one touch electrode is formed by a continuous conductive layer, and the at least one touch electrode has at least one via hole penetrating the conductive layer.

2. The touch panel according to claim 1, further comprising: a fingerprint recognition component on a side opposite to an operation surface of the touch panel.

3. The touch panel according to claim 2, wherein the fingerprint recognition component comprises a light source, the light source being configured such that light emitted from the light source passes through the touch electrode at least through the via hole.

4. The touch panel according to claim 2, wherein the fingerprint recognition component comprises a light sensor configured to sense light reflected at the operation surface of the touch panel.

5. The touch panel according to claim 1, wherein a material of the at least one touch electrode is a transparent conductive material.

6. The touch panel according to claim 1, wherein the at least one touch electrode is configured to perform a touch detection operation through a self-capacitance manner or a mutual capacitance manner.

7. The touch panel according to claim 1, wherein the at least one touch electrode comprises a plurality of via holes which are uniformly distributed.

8. The touch panel according to claim 1, wherein the via hole is filled with a transparent material, and an absolute value of a difference between a refractive index of the transparent material and a refractive index of the base substrate is smaller than an absolute value of a difference between a refractive index of the at least one touch electrode and the refractive index of the base substrate.

9. The touch panel according to claim 8, further comprising: a protective layer on the at least one touch electrode, wherein a portion of the protective layer is filled in the at least one via hole to serve as the transparent material filled in the at least one via hole.

10. The touch panel according to claim 1, wherein a section of the via hole parallel to the base substrate has a shape of at least one selected from the group consisting of a circle, a rectangle, and a hexagon.

11. The touch panel according to claim 1, wherein the via hole has a hole diameter in a range from 0.3 mm to 0.6 mm

12. The touch panel according to claim 1, wherein the at least one touch electrode comprises a plurality of touch electrodes, the plurality of touch electrodes are arranged in a two-dimensional array, and the touch electrodes arranged in a row direction or in a column direction among the plurality of touch electrodes are connected in series by a plurality of bridge portions, and the via hole is outside the plurality of bridge portions.

13. The touch panel according to claim 1, wherein the touch panel comprises a fingerprint detection area, and the at least one via hole is in the touch electrode located in the fingerprint detection area.

14. The touch panel according to claim 1, further comprising:
a polarizer on a side of the touch electrode away from the base substrate.

15. A touch device, comprising the touch panel according to claim 1.

16. The touch device according to claim 15, further comprising a display structure configured to display according to display data.

17. The touch device according to claim 16, wherein the display structure comprises a display light source configured to also serve as a light source for fingerprint recognition, and light emitted by the display light source passes through the touch electrode at least through the via hole.

18. The touch device according to claim 16, wherein the display structure comprises at least one selected from the group consisting of an organic light emitting diode display array, a quantum dot light emitting diode display array, and a liquid crystal display module.
